(19) United States
(12) Patent Application Publication
(10) Pub. No.: US 2010/0001534 A1
(43) Pub. Date: Jan. 7, 2010

(54) Electric Power Generation System Using Hydro Turbine Tracted by Paraglider

(76) Inventor: Jongchul Kim, Daejun (KR)

Correspondence Address: PARK LAW FIRM, 3255 WILSHIRE BLVD, SUITE 1110, LOS ANGELES, CA, 90010, US

(21) Appl. No.: 12/443,636

(22) PCT Filed: Oct. 19, 2006
(86) PCT No.: PCT/KR2006/004271

§ 371 Date: Mar. 30, 2009

(51) Int. Cl. F03D 9/00; F03B 13/00

(52) U.S. Cl. 290/55; 290/52

(57) ABSTRACT

As an electric power generation system using the high altitude wind which is more steady and stronger at the high altitude up to about 15Km above sea level, the power generation system consists of a rotary generator (8) derived by a hydro turbine (7) attached under a ship-like floating platform (5) towed by a parafoil (1) flying at high altitude, controlled by a servomotor (3), which is remotely controlled through electric wire or wireless communication. Accordingly, the diameter of the turbine driven by sea water is reduced as 1/20 in comparison with the windmill which uses directly high altitude wind, and the periodical maintenance becomes convenient by locating the heavy mechanical moving parts near the surface of sea.

### TECHNICAL FIELD

This invention relates to the generation of electricity using the wind power; and more particularly, to the generation of electricity with a hydro turbine towed by a paraglider flying at high altitude.

### BACKGROUND ART

Using windmills on the ground is an obvious and general way to generate electricity from the wind, however, it has many problems conflicting each other as an aspect of promoting efficiency. The windmills which use even moderate wind are not appropriate for sudden and strong gust. Because the winds near the ground (the surface wind) are capricious and not strong enough in comparison with the wind at high altitude.

It is very expensive to build a high tower to use the wind at high altitude. To avoid building a high tower, the methods of using a self floating power generator in the air such as windmill attached to an airship or rotors of a gyrocopter are sometimes adopted. (U.S. Pat. No. 4,470,563, U.S. Pat. No. 6,781,254 B2 and etc.)

At the higher altitude, we can get more abundant and cleaner wind power but the rotor staying in high altitude is not safe and not easy for maintenance.

### DISCLOSURE OF INVENTION

### Technical Problem

The amount of solar energy that reaches to the outer atmosphere is 10,000 times more than the amount of energy human beings need. From 30% to 99% of the solar energy is absorbed into the atmosphere, then it turns into a mechanical power; ‘wind’. So the wind power in the atmosphere is 270 times more than human beings need. However, the wind power is not distributed evenly but concentrated in the upper air.

The average wind velocity at the altitude of 5 Km is 20 m/s and even 40 m/s at the altitude of 10-12 Km between 20 degrees and 35 degrees north latitude. So the wind power density in this region is up to 5,000˜10,000 watts/m². Because of its steady velocity, it is considered as one of hopeful energy sources for the future. But it is not easy to actualize as a safe and economical energy resource.

The purpose of this invention is to promote safety by minimizing the weight and the mechanism of structure which is operating in the upper air.

### Technical Solution

According to the invention, the electricity is generated by the rotary generator (8) mounted on or beneath the ship-like floating platform, driven by the hydro turbine (7) attached under the ship-like floating platform (5), which is towed by the paraglider controlled by the electro mechanical servo motor (3), in FIG. 1.

Such an electricity generation system which can move relatively free in the sea, can get off the typhoon area, furthermore go around the ideal area for the wind power generation; its operation rate of wind power generation is high.

And what is more, in the case that it can not find the proper wind energy source, it can move and anchor at the sea of strong tidal stream, and generates power with the hydro turbine derived by the tidal stream.

The parafoil of the paraglider (1) towing the generation system is composed of a plurality of airfoil cells self inflatable by the incoming air through the air-intake (2) such as most paraglider, whereas the surface area of the parafoil can be reduced as it needs, over a certain limit of the wind velocity, by closing the air-intakes (2) by the wire (4) operated by the servo motor (3). As the surface area of the parafoil decreases, the lift is diminished accordingly. Eventually the self-inflatable parafoil can get the effect of negative angle of attack.

In addition to the characteristic to reduce the air-intake area as it needs, the method of three-axis attitude control such as pitch, roll and yaw is same as in paragliding, where the pilot pulls the control lines of leading edge and trailing edge to change the angle of attack of corresponding airfoil surface by his hands, but by the servo motor (3) remotely controlled by electric wire or wireless communication.

As the pilot sometimes changes his position hanging from the parafoil in right and left side for roll control in a free-flying paragliding, the tethered paraglider can achieve the roll control effect by adjusting the length of the left riser and the right riser from the tether line, which is derived by the remotely controlled servo motor(3).

Accordingly the direction and the magnitude of the traction force derived from the high altitude wind energy through the parafoil, exerted on the tether line, can be selected easily, because the three axis attitude control of the tethered paraglider is possible without great difficulty.

### Advantageous Effects

The tethered paraglider, which is the structure adopted in this invention to extract the energy from the high quality wind existing at high altitude, is light in the aspect of the mass per unit area and the forces exerted on the structure are mainly tensile, therefore it is light-weight and free of serious safety problem. Also it reduces the requirement of maintenance because of little moving parts.

And the diameter of the hydro turbine blade decreases less than 1/20 of the diameter of the windmill rotor blade when we use directly winds, by using the water of which density is 800 times of the air, to derive the hydro turbine for extracting the energy originally from winds; it reduce the cost of turbine manufacturing.

In addition, the operation rate of wind power generation is high, because it can get off the typhoon area and move to the better area for wind power as the seasonal upper-air condition. In case that the wind power is not available, it is possible to generate with tidal stream in anchorage at the place of strong tidal stream.

### BRIEF DESCRIPTION OF THE DRAWINGS

FIG. 1 shows a rotary electricity generator derived by a hydro turbine mounted beneath a ship-like floating platform towed by a paraglider flying at high altitude.

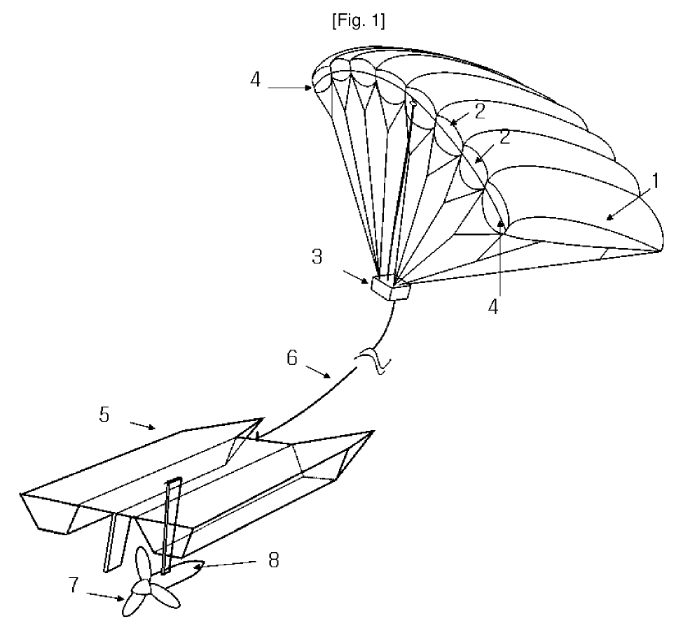

FIG. 2 shows the scheme where two paraliders are connected in cascade to reduce the weight of tether line to tow a ship-like floating platform.

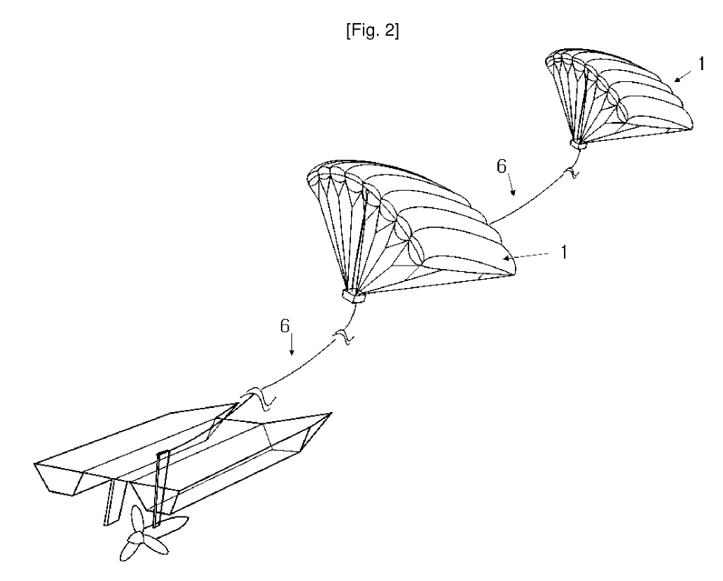

Symbol's Explanation in the FIGclaimS.

1: parafoil of paraglider

2: air-intake of airfoil cell of parafoil

3: electro mechanical servo motor remotely controlled

4: wire to reduce the air-intake's area

5: ship-like floating platform

6: tether line

7: hydro turbine

8: rotary generator

### BEST MODE FOR CARRYING OUT THE INVENTION

The tethered paraglider controlled by FBY (Fly-By-Wire) would fly up at least 500 M above sea level to gather the plenty wind power in this invention. Even though the mechanical moving parts are minimized, the electricity is required in the upper air for de-icing, lightings for aircraft collision avoidance and for driving FBW servo motor. The electricity can be recharged to a battery at the time of periodic maintenance or through the electric wire from the floating platform. But we can reduce frequency of landings by using regular rotary windmills or solar batteries mounted on the parafoil.

It is better to install the hydro turbine generator under the floating platform for the stability against wave, but it is inconvenient for maintenance. It's desirable to lift up the hydro turbine and generator on the floating platform in case of maintenance.

It is desirable to gather the wind power at the altitude of 10 Km above by using the cascaded tethered paraglider technique, after the system of air traffic control for the tethered paraglider and aircraft is settled and the tethered paraglider is spread.

### Mode for the Invention

As this invention is based on existing technologies, there isn't much practical restrictions.

### Industrial Applicability

According to this invention, the expenses to generate can be dramatically reduced but the electricity transfer through cable causes complicated problems. Those problems can be solved by charging fuel cells or liquefied hydrogen store after electrolysis-type hydrogen generation and deliver them at landing piers.

The industrial applicability of the aerial platform network consists of the group of tethered paraglider which stays in air over 500 meter or 5 Km above the sea level is enormous.

It will contribute for happiness of mankind to produce the clean energy in parallel with monitoring ocean environmental status, search for victims from shipwreck or radio communication relay network.

1. A method and device to acquire the electric energy with a hydro turbine for generating electrical power attached under the ship-like floating platform towed by a paraglider controlled by a remotely controlled servomotor to utilize the wind power at high altitude in an ocean.

2. A method and device to reduce the area of air-intakes of a parafoil such as a free flying paraglider by a wire connected to a remotely controlled servomotor, to get a negative angle of attack effect on the parafoil.

3. The method according to claim 1, is characterized in using the parafoil at high altitude for communication relaying.

4. The method according to claim 1, is characterized in that the said parafoils are connected in cascade to reduce the weight of tether line to tow the hydro turbine generator attached under the ship-like floating platform.
